(19) United States
(12) Patent Application Publication
(10) Pub. No.: US 2007/0229482 A1
(43) Pub. Date: Oct. 4, 2007

(54) Image data display control device

(76) Inventors: Hiroyuki Morinaga, Kyoto (JP); Hiroyuki Kageyama, Kyoto (JP); Tsutomu Sakakibara, Kyoto (JP); Tatuo Itoman, Kyoto (JP); Naoto Osaka, Kyoto (JP)

Correspondence Address: MCDERMOTT WILL & EMERY LLP, 600 13TH STREET, NW, WASHINGTON, DC, 20005-3096, US

(21) Appl. No.: 11/730,831

(22) Filed: Apr. 4, 2007

(30) Foreign Application Priority Data
Apr. 4, 2006 (JP) 2006-102743

(51) Int. Cl. G09G 5/00

(52) U.S. Cl. 345/204

(57) ABSTRACT

A memory access switchover circuit relays a data access to the image memory by a writing control circuit and a data access to the image memory by the display control circuit. A blanking period change control circuit extends the blanking period in a display frame at timing of reception of start of the writing operation upon receiving the start of the writing operation to the image memory by the wiring control circuit. The writing control circuit outputs a request for writing the image data to the memory access switchover circuit upon receiving the input of the image data. The memory access switchover circuit switches from the data access by the display control circuit to the data access by the writing control circuit when the request for writing is received.

### BACKGROUND OF THE INVENTION

1. Field of the Invention

The present invention relates to an image data display control device comprising an image memory for temporarily memorizing an image data fetched from outside, a writing control circuit for controlling a writing operation of the image data fetched from outside in relation to the image memory, and a display control circuit for reading the image data from the image memory and transferring/outputting the read image data as a display data.

2. Description of the Related Art

In the case where a transfer cycle of an image data transferred from outside and a display cycle in a display device are different to each other in a image data display control device, it is necessary to convert a frame frequency. In order to convert the frame frequency, an image memory is generally provided in the image data display control device. The image memory functions as a buffer for memorizing the image data temporarily. However, in the case where the image memory has such a small memory capacity that corresponds to one screen, a former frame data and a rewritten frame data are present in a mixed state in the memory when writing of the image data from outside is generated during displaying an image. Then, the mixed data is transferred to the display device, which causes disarrangement of the image. Specially, in the case where the displayed part is related to such a display device that can be rotated, in particular, a direction where the display data is scanned and a direction where the image data is rewritten on the screen intersect with each other in the display device, which makes the image upset more remarkable.

There is an example described below as a conventional constitution for preventing the image disorder. A group of memories having a memory capacity corresponding to two screens totally and each having a memory corresponding to one screen are provided, and a writing pointer for designating the image memory in which the image data is written and a reading pointer for designating the image memory from which the image data is read for displaying are controlled in relation to the group of image memories. Accordingly, it can be avoided to overlap the image memories for writing an image data and reading an image data for displaying.

FIG. 11 is a block diagram showing a constitution of a conventional image data display control device. An image memory comprises a first, a second, . . . , an Nth image memories 20 divided into a capacity unit by one screen respectively, and constitute the before-mentioned group of image memories. A writing control circuit 21 selects the image memory in which an image data from an external device A is to be written, and transfers the image data inputted from outside to the selected image memory. A display control circuit 22 designates the image memory 20 from which the image data is transferred to a display device B. An image processing circuit 23 reads the image data for displaying and transferring from the image memory 20 designated by the display control circuit 22 and transfers the read image data to the display device B.

FIGS. 12A and 12B are flow charts illustrating the operation of the conventional image data display control device, wherein FIG. 12A shows the image data writing flow, and FIG. 12B shows the image data transfer flow to the display device B.

The image memory 20 as the transfer destination is designated through the writing control circuit 21, and then, the image data by one screen is transferred to the designated image memory 20. After the transfer is done, a latest image information is appended to the designated image memory 20, and the pointer for designating the image memory as a writing target 20 is changed to an (N+1)th image memory.

The image memory 20 in which the latest image information is stored is designated as the reading pointer by the display control circuit 22, and the latest image information is cleared from the relevant image memory 20. After that, when the reading operation, wherein the image data for display by one screen is read from the image memory 20, is completed, it is confirmed if there is any other image memory 20 that includes the latest image information. In absence of any other image memory 20 to which the latest image information is appended, the same image memory 20 is designated again as the reading pointer.

As a result of the foregoing control operation, the image memory 20 to which the image data is written and the image memory 20 from which the image data is read and transferred to the display device B can be designated without duplication between them. Herewith, the state where the former and new frame image data are present in a mixed state can be prevented, and the image data for displaying is transferred to the display device B all the time after the transfer of the latest image data is completed. As a result, the image disorder in the display device B can be avoided.

However, in the conventional constitution, the image memories having the memory capacity corresponding to the plurality of screens are provided, which leads to cost overrun due to the increased memory capacity. Further, a yielding percentage is reduced through the highly integrated memories.

According to high integration of a semiconductor, it is more likely that the image memory is incorporated in a control system LSI, which cannot be easily responded in the conventional constitution and is actually unsuitable for such a high-density packaging that is necessary for a circuit provided in a mobile phone circuit and the like due to an increasing chip size of the control system LSI.

### SUMMARY OF THE INVENTION

Therefore, a main object of the present invention is to prevent any disorder in a displayed image without increasing a capacity of an incorporated image memory.

In order to solve the foregoing problem, an image data display control device according to the present invention comprises:

an image memory for memorizing an image data temporarily;

a writing control circuit for writing the image data in the image memory during a blanking period at the time of displaying an image when the image data is inputted thereto;

a display control circuit for reading the image data from the image memory during a display period when the image is displayed;

a memory access switchover circuit for relaying a data access to the image memory by the writing control circuit and a data access to the image memory by the display control circuit to each other and

a blanking period change control circuit for extending the blanking period in a display frame at a timing of receiving start of the writing operation with respect to the image memory by the wiring control circuit when the start of the writing operation is received, wherein

the writing control circuit outputs a request for writing the image data to the memory access switchover circuit in response to the input of the image data, and

the memory access switchover circuit switches from the data access by the display control circuit to the data access by the writing control circuit when the request is received.

In the foregoing constitution, in a normal display frame where the image data from outside is not written, the blanking period change control circuit sets a normal blanking period, and the memory access switchover circuit selects the data access by the display control circuit. In the display period after the blanking period is over, the display control circuit reads the image data from the image memory and transfers the read image data to the display device. In the next blanking period after the display period is over, fly-back lines processing is performed so as to proceed on to the processing during the display period again.

In a competitive frame in which the image data is written, the blanking period change control circuit extends the blanking period, and the memory access switchover circuit selects the data access to the image memory by the writing control circuit. As a result, the writing control circuit writes the image data in the image memory. The image data is written through the writing control circuit within a time length of the extended blanking period. When the extended blanking period is over, the access to the image memory is returned to the display control circuit.

Furthermore, in order to perform the foregoing control, it is preferable that the blanking period change control circuit extends the blanking period of the display frame at the timing of reception of start of writing and restores the blanking period of the next frame to a normal time length thereof when the start of the writing operation to the image memory by the wiring control circuit is received.

Further, it is preferable that the blanking period change control circuit sets the extended blanking period so as to have an enough time for the writing control circuit to write the image data in the image memory. Herewith, the image data in the image memory is updated in the blanking period that is extended to be long enough to not affect the displayed image.

Additionally, the memory access switchover circuit restricts the access to the image memory to the access by the writing control circuit within the time range of the extended blanking period supplied from the blanking period change control circuit in the competitive frame. More specifically, the image memory is occupied solely with the writing operation until the image data writing operation is completed. Therefore, the image data can be written in such a manner that any disorder is not generated in the image because the state where a mixed state of the former and new frame data are not generated even when the image memory having the memory capacity corresponding to one screen is used. As a result, it becomes unnecessary to consider countermeasure with respect to avoiding any competitive memory access and deterioration of a transfer rate.

As described, according to the present invention, the state where the former and new frame data are present in a mixed state can be avoided, while increase of costs for installation of the memory, deterioration of a yielding percentage due to a higher integration of the memory, increase of a chip size of a control system LSI and the like, are prevented at the same time.

Furthermore, there is an embodiment that the blanking period change control circuit returns the extended blanking period to the original period in response to termination of the writing operation to the image memory by the writing control circuit.

It is necessary to set the extended time length counting on a relatively large value in order to make possible to respond to either of the image data of different data sizes in a constitution wherein a certain extended time is simply added to the normal blanking period. However, the writing operation is completed before the extended blanking period is over in the case of the image data of a relatively short data size, and the time period between the termination of the writing operation and the termination of the blanking period is wasted. More specifically, a frame frequency is reduced to an unnecessarily low level in consequence of the extension of the blanking period in the competitive frame. Correspondingly, according to the present embodiment, the extended blanking period is terminated sooner in the case of the image data having a smaller data size, in other words, any unnecessary extension of the blanking period can be avoided. Therefore, the reduction of the frame frequency resulting from the extension of the blanking period can be alleviated.

Furthermore, there is an embodiment that the display control circuit sets a data reading frequency in the extended blanking period to be higher than the data reading frequency in the blanking period that is not extended. Accordingly, the frame frequency can be further reduced by executing readout of the image data from the image memory in the competitive frame at a faster frequency than that in the normal display frame.

Additionally, there is an embodiment that the blanking period change control circuit reduces the blanking period based on the frame in which the blanking period is extended in any frame on and after the relevant frame. Accordingly, after the competitive frame is terminated, the blanking period is made shorter than the normal blanking period so that fly-back lines are processed at a higher speed in the conventional frame in which the image data from outside is not written. Further, the image data is read from the image memory at a faster frequency than that of the normal display frame, and the frame frequency can be further reduced. The frame subject to such processing is assumed as a normal display time reduction frame. There may be either one or plural normal display time reduction frame. As a result, the frame frequency can be set to be close to an existing frame cycle.

Besides, there is an embodiment that the image data display control device may further comprise an output drivability adjusting circuit for adjusting a signal level of the image data outputted by the display control circuit, wherein the output drivability adjusting circuit adjusts the signal level in the extended blanking period in accordance with the reading frequency in the relevant blanking period.

In order to raise the frequency, it is necessary to set an output drivability to a high level. However, when the high output drivability is maintained, the normal display frame with a low frequency falls into an over-spec state, and power is thereby unnecessarily consumed. Therefore, the output drivability adjusting circuit is provided so that the output drivability is reduced when the frequency is low in comparison with the case of the high frequency.

According to the present invention, the display image disorder can be prevented even in the case where the image memory having the memory capacity corresponding to one screen is used. In addition to obtaining such effect, the control system LSI can be reduced in size, and a high-density package and price reduction can also be realized.

The image data display control device according to the present invention can display a high-quality image with a minimum image memory capacity, and is useful for an image processing device and the like such as a circuit provided in a mobile device wherein cost reduction and less power consumption and a high-density package are demanded.

### BRIEF DESCRIPTION OF THE DRAWINGS

These and other objects as well as advantages of the invention will become clear by the following description of preferred embodiments of the invention. A number of benefits not recited in this specification will come to the attention of those skilled in the art upon the implementation of the present invention.

FIG. 1 is a block diagram showing a constitution of an image data display control device according to a preferred embodiment 1 of the present invention.

FIG. 2 is a timing chart illustrating an operation of the image data display control device according to the preferred embodiment 1.

FIG. 3 is a block diagram showing a constitution of an image data display control device according to a preferred embodiment 2 of the present invention.

FIG. 4 is a timing chart illustrating an operation of the image data display control device according to the preferred embodiment 2.

FIG. 5 is a block diagram showing a constitution of an image data display control device according to a preferred embodiment 3 of the present invention.

FIG. 6 is a timing chart illustrating an operation of the image data display control device according to the preferred embodiment 3.

FIG. 7 is a block diagram showing a constitution of an image data display control device according to a preferred embodiment 4 of the present invention.

FIG. 8 is a timing chart illustrating an operation of the image data display control device according to the preferred embodiment 4.

FIG. 9 is a block diagram showing a constitution of an image data display control device according to a preferred embodiment 5 of the present invention.

FIG. 10 is a timing chart illustrating an operation of the image data display control device according to the preferred embodiment 5.

FIG. 11 is a block diagram showing a constitution of a conventional image data display control device.

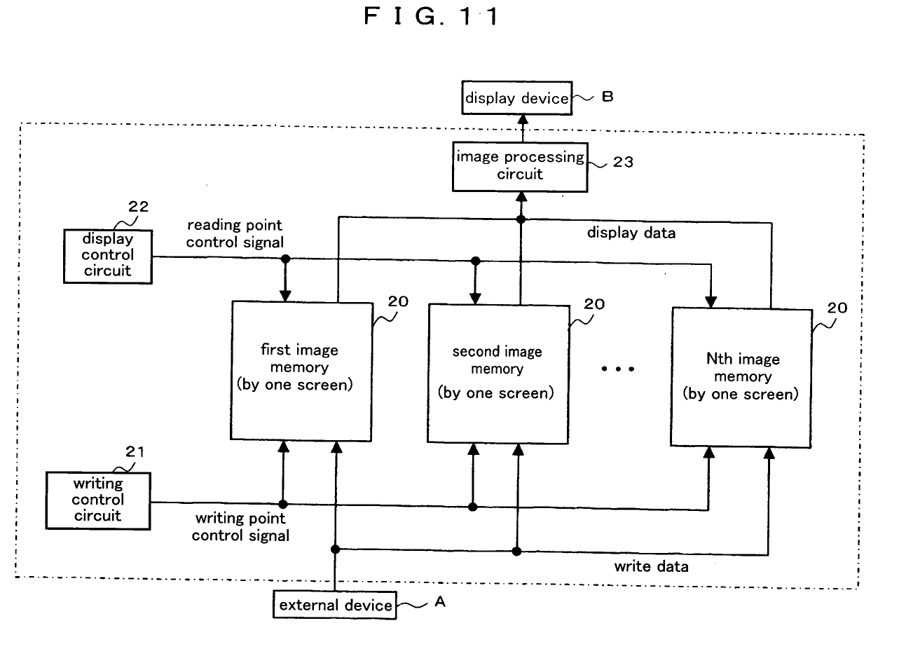

FIGS. 12A and 12B are timing charts illustrating an operation of the conventional image data display control device.

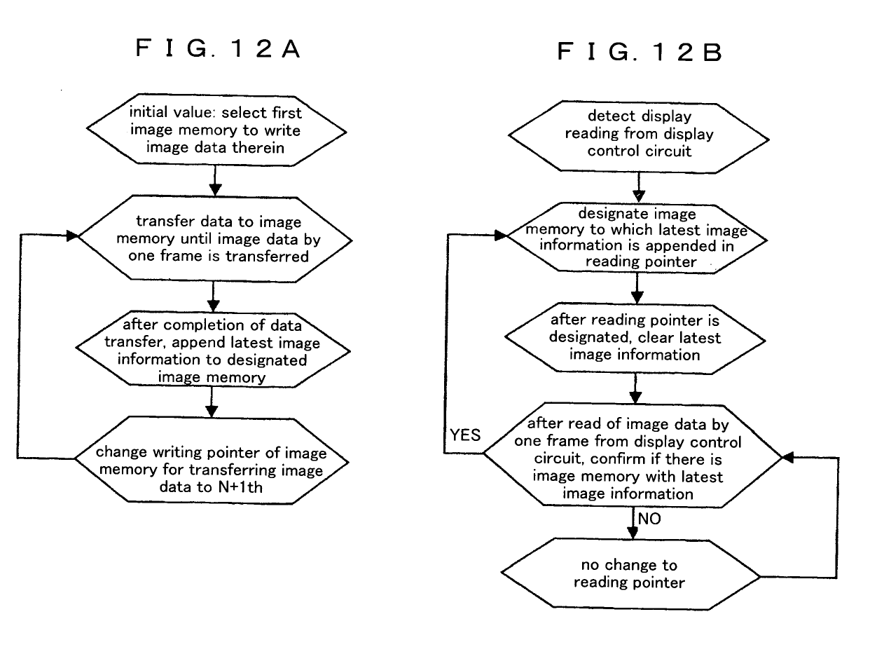

### DETAILED DESCRIPTION OF THE INVENTION

Hereinafter, preferred embodiments of an image data display control device according to the present invention are described in detail referring to the drawings.

A blanking period denotes a vertical fly-back line period (non-display period) between display periods. A frame cycle can be expressed by sum of the display period and the blanking period necessary for display of one screen. Further, the display period can be expressed with the product of a line cycle and number of display lines. A frame frequency can be adjusted by the adjustment of the blanking period or the line cycle. A frame only for an image data reading operation is referred to as a normal display frame F1, while a frame in which the writing and reading operations compete with each other is referred to as a competitive frame F2. The competition means that the writing and reading operations are executed in the same frame, though these operations do not overlap temporally with each other.

### Preferred Embodiment 1

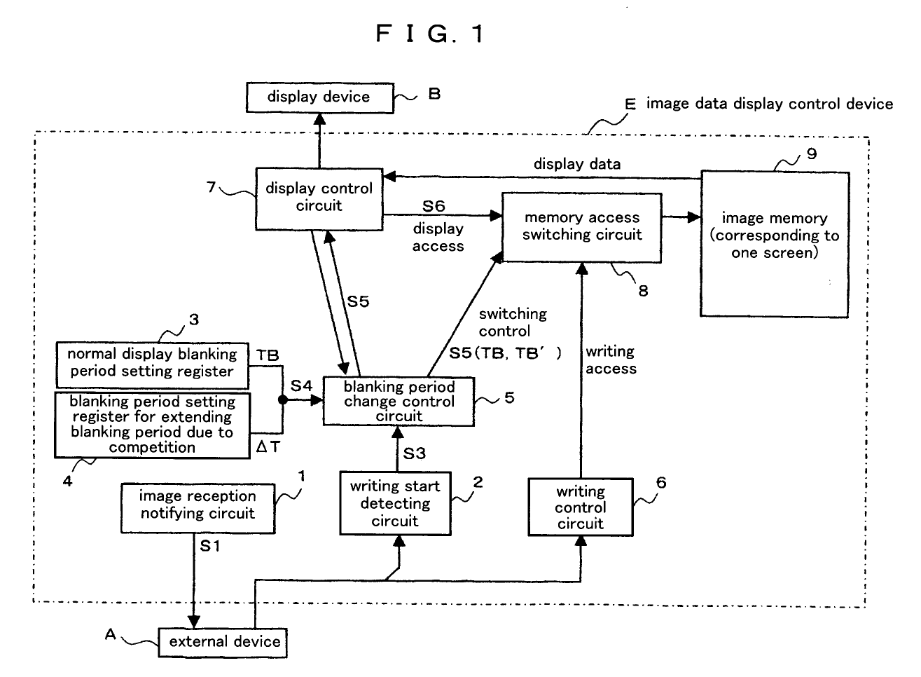

FIG. 1 is a block diagram showing a constitution of an image data display control device E according to a preferred embodiment 1 of the present invention. In FIG. 1, an external device A such as a graphic controller, a display device B such as a liquid crystal panel, and the relevant image data display control device E are shown. The image data display control device E comprises an image reception notifying circuit 1, a writing start detecting circuit 2, a normal blanking period setting register 3, a blanking period setting register 4 for extending a blanking period due to competition, a blanking period change control circuit 5, a writing control circuit 6, a display control circuit 7, a memory access switchover circuit 8, and an image memory 9. The image memory 9 is a frame memory having a memory capacity corresponding to one screen.

The image reception notifying circuit 1 outputs an image data transfer reception start signal S1 to thereby notify the external device A of being in such a state where the image data display control device E can receive the image data from outside.

The writing start control circuit 2 detects start of the writing operation by the external device A during a writing sampling period, generates a writing start signal S3, and outputs the generated writing start signal S3 to the blanking period change control circuit 5.

The normal display blanking period setting register 3 stores therein a set value of a blanking period TB of the normal display frame F1 used when it is notified by the writing start detecting circuit 2 that there is not the image data from outside to be written, and outputs the set value to the blanking period change control circuit 5.

When it is notified by the writing start detecting circuit 2 that there is the image data from outside to be written, the blanking period setting register for competition extension 4 stores therein an extended time AT by which the blanking period TB is extended until the writing operation is completed in order to avoid competition between the writing operation by the external device A and the reading operation, and outputs the extended time ΔT to the blanking period change control circuit 5.

The blanking period change control circuit 5 adjusts a blanking period set value S4 depending on the normal display frame F1 or the competitive frame F2. More specifically, the set value S4 is adjusted so as to be the blanking period TB in the normal display frame F1, while the set value S4 is adjusted so as to be a blanking period TB′ (=TB+ΔT) obtained by adding the extended time ΔT to the blanking period TB in the competitive frame F2. The blanking period change control circuit 5 generates a blanking period signal S5 showing the adjusted set value S4 and outputs the signal S5 to the display control circuit 7 and the memory access switchover circuit 8.

The writing control circuit 6 writes the image data in the image memory 9 in accordance with the writing operation by the external device A. The display control circuit 7 reads the image data from the image memory 9 after the termination of the blanking periods TB and TB′ indicated by the blanking period signal S5 inputted from the blanking period change control circuit 5, and transfers and outputs the read image data to the display device B.

The memory access switchover circuit 8 relays accesses to the image memory 9 by the display control circuit 7. The memory access switchover circuit 8 further switches from the access to the image memory 9 from the access by the display control circuit 7 to the access by the writing control circuit 6 when the writing operation is requested by the writing control circuit 6, and transmits the extended time ΔT of the blanking period by the blanking period change control circuit 5 to the image memory 9. The image memory 9 has a memory capacity capable of storing the image data by one screen.

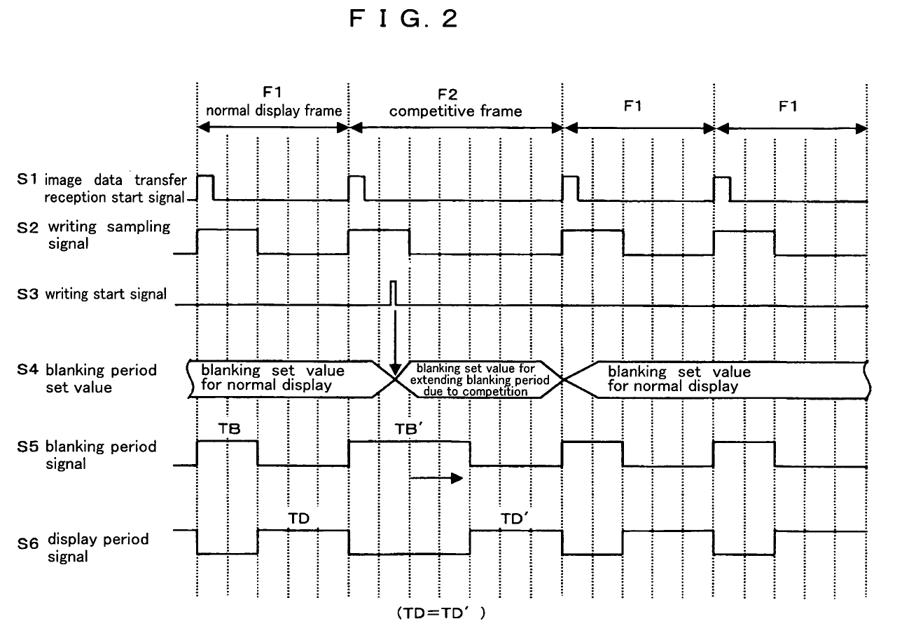

Next, the operation of the image data display control device E according to the present preferred embodiment thus constituted is described referring to a timing chart shown in FIG. 2. Referring to reference symbols shown in FIG. 2, S1 denotes an image data transfer reception start signal outputted from the image reception notifying circuit 1 to the external device A, S2 denotes a writing sampling signal S2 showing a period detecting the writing operation by the external device A, S3 denotes a writing start signal generated in the writing start detecting circuit 2 only when the writing operation by the external device A is detected during a period when the writing sampling signal S2 is at the “H” level, S4 denotes a blanking period set value set by the blanking period change control circuit 5, 5S denotes a blanking period signal showing the blanking period when the display of the image data is halted, and S6 denotes a display period signal showing a display period when the image data is displayed.

When the display period is over and the image data can be received, the image reception notifying circuit 1 transmits the image data transfer reception start signal S1 to the external device A. A time period between the termination of the display period and the output of the image data transfer reception start signal S1 is arbitrarily set. When the image data transfer reception start signal S1 is detected in the state where there is the image data to be transferred, the external device A starts to write the image data in such a state as synchronizing with the writing sampling signal S2 previously set in the image data display control device E, in other words, during the period when the writing sampling signal S2 is at the “H” level.

The writing start detecting circuit 2 monitors whether or not the image data writing operation by the external device A starts during the period when the writing sampling signal S2 is at the “H” level. The writing start detecting circuit 2 generates the writing start signal S3 and outputs the generated signal S3 to the blanking period change control circuit 5 when the start of the writing operation is started.

The blanking period change control circuit 5 changes over the blanking period set value S4 upon the detection of the writing start signal S3. More specifically, when the writing start signal S3 is in the inactive state, the blanking period set value S4 is set to the value which shows the blanking period TB of the normal display blanking period setting register 3 (S4=TB). Meanwhile, when the writing start signal S3 is in the active state, the blanking period set value S4 is set to the value which shows the period TB′ (TB′=TB+ΔT) obtained by adding the extended time ΔT of the blanking period setting register for competition extension 4 to the to the blanking period TB (TB′=TB+ΔT).

Therefore, when the writing start signal S3 is outputted (active state), the blanking period TB is extended to the blanking period TB′ (TB+ΔT). The extended time ΔT set in the blanking period setting register for competition extension 4 satisfies a time of the operation necessary for the image data to be rewritten in the image memory 9 from) the external device A, and all of the writing operations by the external device A are terminated within the extended blanking period TB′. An arrow directed to right, which is shown in the indication column of the blanking period signal S5, denotes the image data writing operation. The blanking period signal S5 generated by the blanking period change control circuit 5 is supplied to the display control circuit 7 and the memory access switchover circuit 8.

When the termination of the blanking period is notified by the blanking period signal S5, the display control circuit 7 sets the display period signal S6 to the “H” level to thereby start the operation in the display period. The display period signal S6 is supplied to the memory access switchover circuit 8. The memory access switchover circuit 8 enables the reading operation of the image memory 9 performed by the display control circuit 7 during a period at the “H” level of the display period signal S6. The image data thereby read from the image memory 9 is transferred to the display device B and displayed therein.

When the transfer of the image data to the display device B is completed, the display control circuit 7 sets the display period signal S6 to the “L” level. Accordingly, the display period is terminated so as to execute a fly-back lines processing, and then the image reception notifying circuit 1 transmits again the image data transfer reception start signal S1 to the external device A. The operations described above are repeated.

The memory access switchover circuit 8 switches over the access to the image memory 9 by the writing control circuit 6 (only the blanking period) and the access to the image memory 9 by the display control circuit 7 (only the display period) based on the blanking period signal S5. Thereby, the writing control circuit 6 accesses the image memory 9 only during the blanking period to write the image data therein, and the display control circuit 7 accesses the image memory 9 solely in the display period to read the image data. Then, the processing shifts from the competitive frame F2 back to the normal display frame F1 only after the writing operation is completed.

As a result of the foregoing control operation, generation of the state where the image data to be written and the image data to be read are present in a mixed manner in the image memory 9 can be surely prevented, and any image disorder in the display device B can be thereby avoided. Further, the data-mixed state can be prevented while an access occupancy rate in relation to the image memory 9 is maximally maintained at the same time. Moreover, the control operation can be executed without any increase of the memory capacity of the image memory 9 (the memory capacity by one screen is maintained) As a result, cost reduction and deterioration of a yielding percentage due to a higher integration of the memory can be avoided, and a chip size of the control system LSI can be prevented from increasing.

More detailed description is given below. In the normal display frame F1 wherein the image data writing operation is not generated, the writing operation by the external device A is not detected during the period when the writing sampling signal is at the “H” level (sampling period). Therefore, the value of the normal display blanking period setting register 3 is referenced as the blanking period set value S4, and the blanking period (more specifically, blanking period signal S5) is decided. In this case, the blanking period is TB. After the termination of the blanking period TB, a display period TD of the normal display frame F1 is started. During the display period TD, the image data is read from the image memory 9 and transferred to the display device B to be displayed therein.

Meanwhile, in the competitive frame F2 in which the image data writing operation is generated, when the writing operation by the external device A is detected during the sampling period, the writing start signal S3 is outputted. At the time, the extended time ΔT of the blanking period setting register 4 is referenced as the blanking period set value S4, and the extended blanking period TB′ is set based on the referenced extended time ΔT. The writing operation of the image memory 9 by the external device A is completed within the extended blanking period TB′. In synchronization with the termination of the blanking period TB′, a display period TD′ of the competitive frame F2 is started. In the present preferred embodiment, the display period TD of the normal display frame F1 and the display period TD′ of the competitive frame F2 are set to an equal time length (TD=TD′).

As described above, according to the present preferred embodiment, the blanking period TB′ of the competitive frame F2 where the image data writing operation is generated is set to such a time length that satisfies a time necessary for the writing operation of the image memory 9 by the external device A to be completed. As a result, the image data can be updated within the sufficiently long blanking period that does not affect the displayed image so that the image disorder can be prevented.

The memory access switchover circuit 8 controlled by the blanking period signal S5 restricts the access to the image memory 9 to the writing access by the external device A during the blanking period, and to the reading access by the display control circuit 7 during the display period. Thereby, the image memory 9 becomes a complete one-port operation, wherein the image memory 9 is no longer simultaneously accessed through the display control circuit 7 and the memory access switchover circuit 8, and the respective accesses are completely separated from each other temporarily. Therefore, it becomes unnecessary to take actions for avoiding the competition in the memory accesses and deterioration of the transfer rate when the one-port memory is used, and a writing throughput to the external device A can be maximized even though the inexpensive one-port memory constitutes the image memory 9. As a result, the image memory 9 having the memory capacity corresponding to one screen can be used, which prevents the cost increase and deterioration of the yielding percentage due to a higher integration. Further, the increase of the chip size of the control system LSI can be controlled.

### Preferred Embodiment 2

In the aforementioned preferred embodiment 1, when the blanking period is once extended in the competitive frame F2, the extended blanking period is always maintained until the termination of the extended blanking period TB′ (=TB+ΔT) obtained by adding the certain extended time AT to the blanking period TB in the normal display frame F1. In other words, the extended blanking period TB′ is fixedly used. However, when the writing operation to the image memory 9 by the external device A is completed before the extended blanking period TB′ is terminated, a period of time between the completion of the writing operation and the termination of the extended blanking period TB′ is wasted. More specifically, the frame frequency may be reduced to an unnecessarily low level if the blanking period is extended in the competitive frame F2. A preferred embodiment 2 of the present invention can avoid the inconvenience.

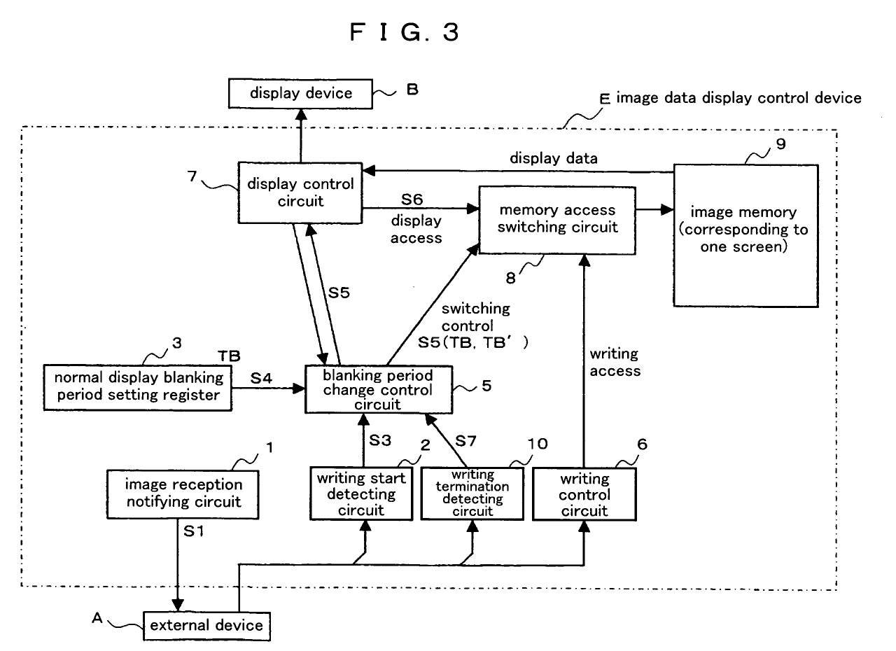

FIG. 3 is a block diagram showing a constitution of an image data display control device E according to the preferred embodiment 2. The reference symbols shown in FIG. 3, which are the same as those shown in FIG. 1 according to the preferred embodiment 1, denote the same components. The constitution according to the present preferred embodiment is characterized as follows. A reference numeral 10 denotes a writing termination detecting circuit for detecting the termination of the writing operation by the external device A. A blanking period change control circuit 5 according to the present preferred embodiment decides the blanking period TB in accordance with the normal display blanking period setting register 3 in the normal display frame F1, and immediately forces the termination of the extended blanking period TB′ when a writing termination signal S7 is notified by the writing termination detecting circuit 10 in the competitive frame F2. The rest of the constitution is similar to that of the preferred embodiment 1 and is not described again.

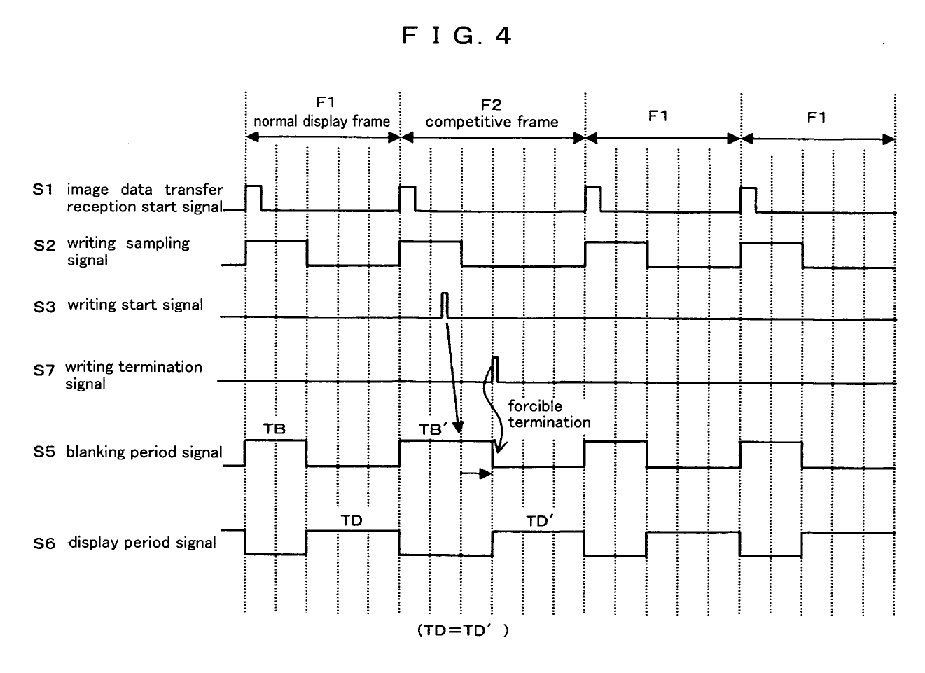

Next, the operation of the image data display control device E according to the present preferred embodiment thus constituted is described referring to a timing chart shown in FIG. 4. In FIG. 4, the same reference symbols as those shown in FIG. 2 according to the preferred embodiment 1 denote the same signals.

In FIG. 4, S7 denotes a writing termination signal outputted by the writing termination detecting circuit 10 when the writing termination detecting circuit 10 detects that the writing operation to the image data by the external device A is completed after the writing start detecting circuit 2 outputs the writing start signal S3.

Here, it is described below with a focus on the operations of the writing termination detecting circuit 10 and the blanking period change control circuit 5. In the blanking period change control circuit 5, the blanking period TB is decided in accordance with the value of the normal display blanking period setting register 3 in the normal display frame F1, and the blanking period is extended when the writing start signal S3 is received from the writing start detecting circuit 2 in the competitive frame F2. When the termination of the writing operation is notified by the external device A, the writing termination detecting circuit 10 generates the writing termination signal S7 and outputs the generated signal S7 to the blanking period change control circuit 5. Upon receiving the writing termination signal S7, the blanking period change control circuit 5 forcibly terminates the extension of the blanking period (TB′).

Therefore, at the timing of the completion of the writing operation to the image memory 9 by the external device A, the writing termination signal S7 is generated, and the blanking period signal S5 is forcibly decayed based on the generated writing termination signal S7. Therefore, the blanking period can be prevented from being unnecessarily extended. The extended blanking period TB′ in the case where the present preferred embodiment is implemented is shorter than the extended blanking period TB′ in the case where the preferred embodiment 1 is implemented. Therefore, the frame frequency can be prevented from being reduced to an unnecessarily low level. Depending on the circumstances, the blanking period TB′ may be extended to have the time length similar to that of the preferred embodiment 1.

In the present preferred embodiment, as a result, the time lengths of the display period TD of the normal display frame F1 and the display period TD′ of the competitive frame F2 are equal to each other (TD=TD′). Further, the writing termination detecting circuit 10 may automatically detect the input of the notification from the external device A or the termination of the accesses within the writing range and output the writing termination signal S7 in place of the foregoing control operation.

As described above, according to the present preferred embodiment, any unnecessary extension of the blanking period can be avoided because the termination of the writing operation is automatically acknowledged based on the data size of the image data in addition to the effect described in the preferred embodiment 1. Therefore, in comparison to the preferred embodiment 1, the reduction of the frame frequency resulting from the extension of the blanking period can be further alleviated.

### Preferred Embodiment 3

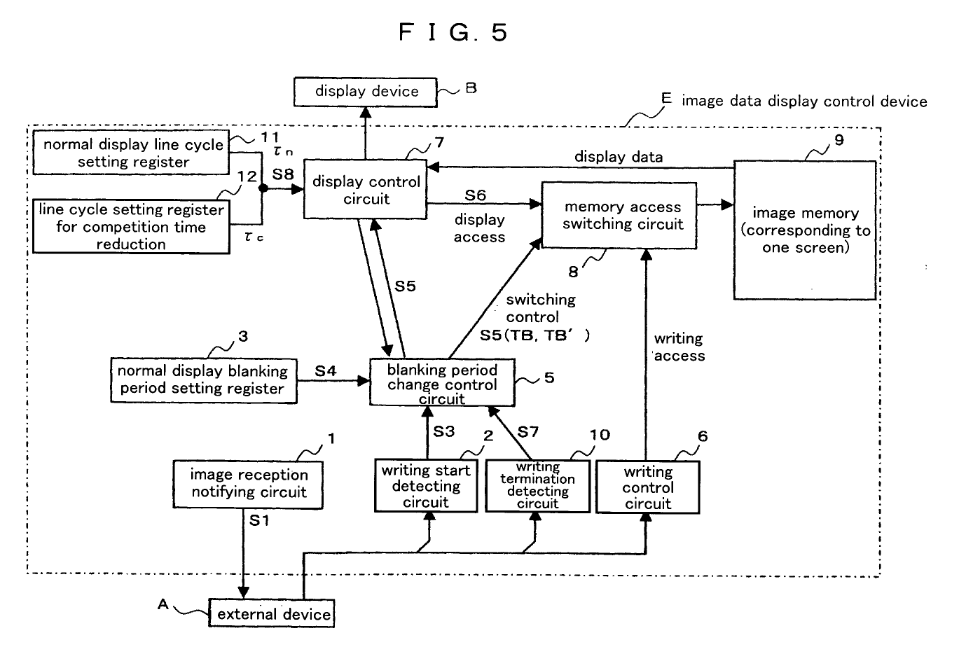

A preferred embodiment 3 of the present invention further enhances the prevention of the reduction of the frame frequency based on the constitution according to the preferred embodiment 2. FIG. 5 is a block diagram showing a constitution of an image data display control device E according to the preferred embodiment 3. In FIG. 5, the same reference symbols as those shown in FIG. 3 according to the preferred embodiment 2, denote the same components. The constitution according to the present preferred embodiment is characterized as follows.

A reference numeral 11 denotes a normal display line cycle setting register wherein a line cycle set value S8 in the normal display frame F1 is stored. The line cycle set value S8 is used when it is notified by the writing start detecting circuit 2 that the there is not the image data to be written by the external device A. 12 denote a time-reduction line cycle setting register for storing the line cycle set value S8 for time-contracting the frame cycle lowered by the extension of the blanking period in the competitive frame F2. The line cycle set value S8 is used when it is notified by the writing start detecting circuit 2 that there is the image data to be written by the external device 2.

A display control circuit 7 according to the present preferred embodiment executes the following control operation. Namely, the display control circuit 7 adjusts a reading cycle of the image data while switching over the normal display line cycle setting register 11 and the line cycle setting register 12 for competition time-reduction (TD, TD′) after falling edge of the blanking period signal S5 inputted from the blanking period change control circuit 5, and reads the image data from the image memory 9 based on the adjusted reading cycle and transfers the read image data to the display device B.

The display periods TD and TD′ are shown as the examples of the line cycle set value S8. However, the reading operation frequency when the display control circuit 7 reads the image data from the image memory 9 and transfers the read image data to the display device B is actually adjusted. Provided that the reading operation frequency corresponding to the display period TD is f, and the reading operation frequency corresponding to the display period TD′ is f′, it becomes

f∝1/TD

f′∝1/TD

(f<f′)

More specifically, in the competitive frame F2, the image data is read from the image memory 9 at the reading operation frequency f′ higher than in the normal display frame F1. The rest of the constitution is similar to that of the preferred embodiment 2 and explanation is neglected.

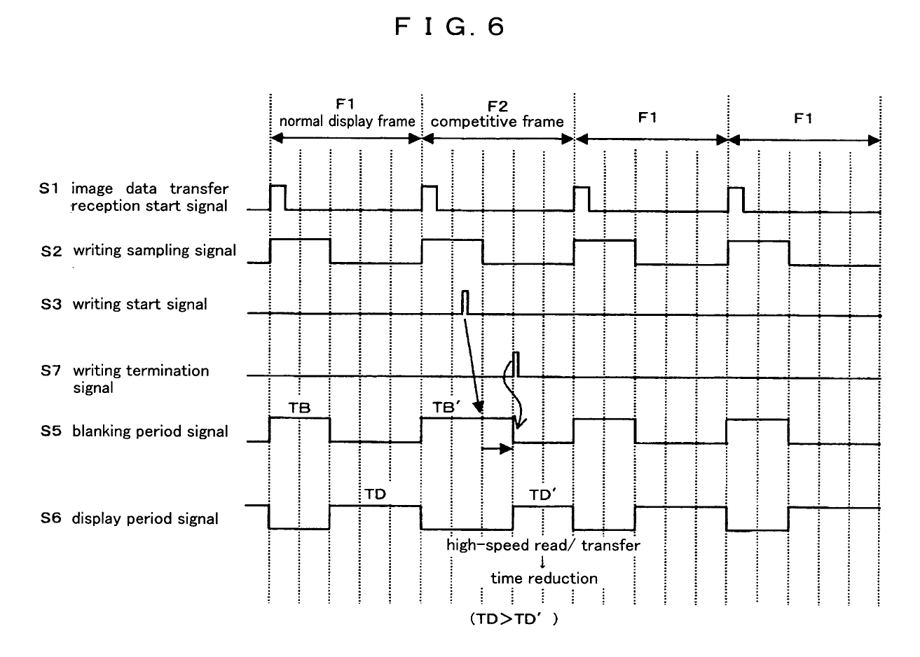

Next, the operation of the image data display control device E according to the present preferred embodiment thus constituted is described referring to a timing chart shown in FIG. 6. In FIG. 6, the same reference symbols shown as those shown in FIG. 4 according to the preferred embodiment 2 denote the same signals. The description is given below with a focus on the operations of the display control circuit 7, the normal display line cycle setting register 11, and the line cycle setting register for competition time-reduction 12.

In the display control circuit 7, the line cycle set value S8 of the normal display line cycle setting register 11 is selected in the normal display frame F1, and the display period TD of the normal display period is decided based on the product of the line cycle set value S8 and the number of the display lines. Further, the line cycle set value S8 of the time-reduction line cycle setting register 12 is selected in the competitive frame F2, and the time-reduced display period TD′ is decided based on product of the line cycle set value S8 and the number of the display lines. The line cycle set value S8 of the line cycle setting register for competition time-reduction 12 at the time is a shorter cycle than that in the normal display in order to alleviate the reduction of the frame frequency resulting from the extension of the blanking period in the competitive frame F2.

Provided that the line cycle set value S8 in the normal display frame F1 stored in the normal display line cycle setting register 11 is τₙ, and the line cycle set value S8 in the competitive frame F2 stored in the line cycle setting register for competition time-reduction 12 is τ_{c}, τₙ>τ_{c} is obtained.

Provided that the number of the display lines is equal to L, the display period TD in the normal display frame F1 is TD=τₙ×L, and the display period TD′ in the competitive frame F2 is TD′=τ_{c}×L.

Therefore, the result is TD>TD′, and the time of the display period TD′ in the competitive frame F2 in relation to the display period TD in the normal display frame F1 is reduced (time reduction). Further, the reading operation frequencies f and f′ are calculated based on the following calculation formulas.

f=1/τₙ

f′=1τ_{c}

In the normal display frame F1, the display control circuit 7 reads the image data from the image memory 9 based on the lower reading operation frequency f and transfers the read image data to the display device B. Also, in the competitive frame F2, the display control circuit 7 reads the image data from the image memory 9 based on the higher reading operation frequency f′ and transfers the read image data to the display device B. In the competitive frame F2, the necessary display period TD′ is reduced because the image data is read and transferred at a high speed.

As described above, according to the present preferred embodiment, the reduction of the frame frequency can be further alleviated in comparison to the preferred embodiment 2 by reducing a time of the display period TD′ in the competitive frame F2 in addition to the effects described in the preferred embodiments 1 and 2.

### Preferred Embodiment 4

A preferred embodiment 4 of the present invention further promotes the control of the reduction of the frame frequency based on the constitution according to the preferred embodiment 3. In order to alleviate the reduction of the frame frequency resulting from the generation of the competitive frame F2 in an arbitrary number of frames on and after the competitive frame F2, the frame executing time reduction in the frame only for the image data reading operation is made a normal display time-reduction frame F3. The normal display frame F1 is the frame wherein only the image data reading operation is carried out but do not perform the time reduction.

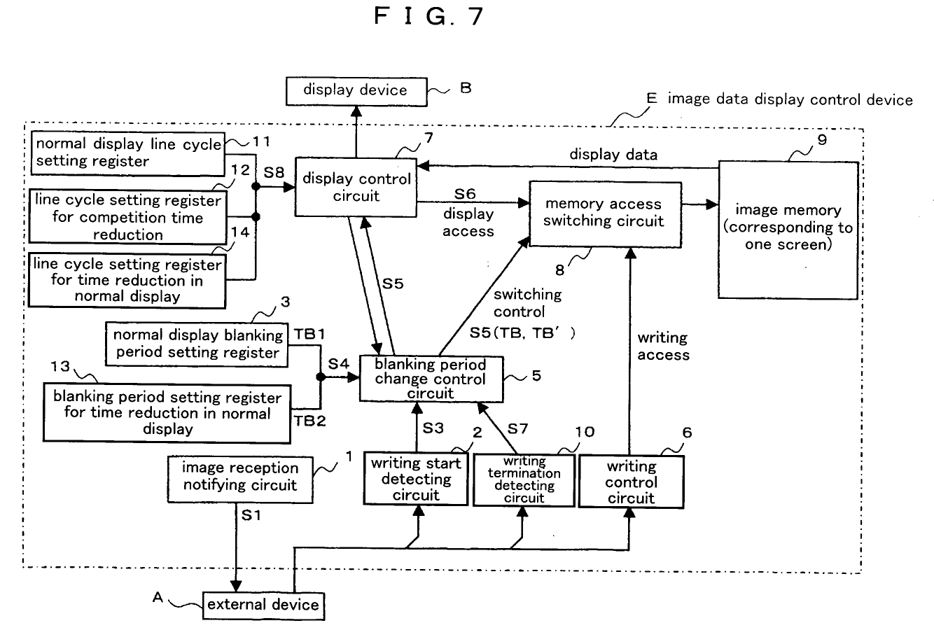

FIG. 7 is a block diagram showing a constitution of an image data display control device E according to a preferred embodiment 4 of the present invention. In FIG. 7, the reference symbols, that are the same as those shown in FIG. 5 according to the preferred embodiment 3, denote the same components. The constitution according to the present preferred embodiment is characterized as follows.

A reference numeral 13 denotes a blanking period setting register for time reduction in a normal display where a blanking period TB2 in the normal display time reduction frame F3 implementing the time reduction is stored. The blanking period TB2 is used when it is notified by the writing start detecting circuit 2 that there is no image data to be written by the external device A in the normal display time reduction frames F3 on and after the competitive frame F2.

A reference numeral 14 denotes a line cycle setting register for time reduction in a normal display where the line cycle set value S8 in the normal display time reduction frame F3 is stored. The line cycle set value S8 is used when it is notified by the writing start detecting circuit 2 that there is no image data to be written by the external device A and the time reduction is executed.

A blanking period change control circuit 5 according to the present preferred embodiment executes the following control operation.
A blanking period TB1 is decided based on the output of the normal display blanking period setting register 3 in the normal display frame F1.
The blanking period is extended until the writing termination signal S7 notified from the writing termination detecting circuit 10 is outputted in the competitive frame F2 (TB1′).
The blanking period TB2 is decided based on the output of the blanking period setting register 13 for time reduction in a normal display in the normal display time reduction frame F3.

A display control circuit 7 according to the present preferred embodiment adjusts the reading cycle of the image data while switching over the normal display line cycle setting register 11, the line cycle setting register for competition time-reduction 12 and the line cycle setting register for time-reduction in a normal display 14 mutually after the blanking period notified by the blanking period change control circuit 5 is terminated. The display control circuit 7 reads the image data from the image memory 9 while making the adjustment, and transfers so as to display the read image data to the display device B. The rest of the constitution is similar to that of the preferred embodiment 3 and description is omitted.

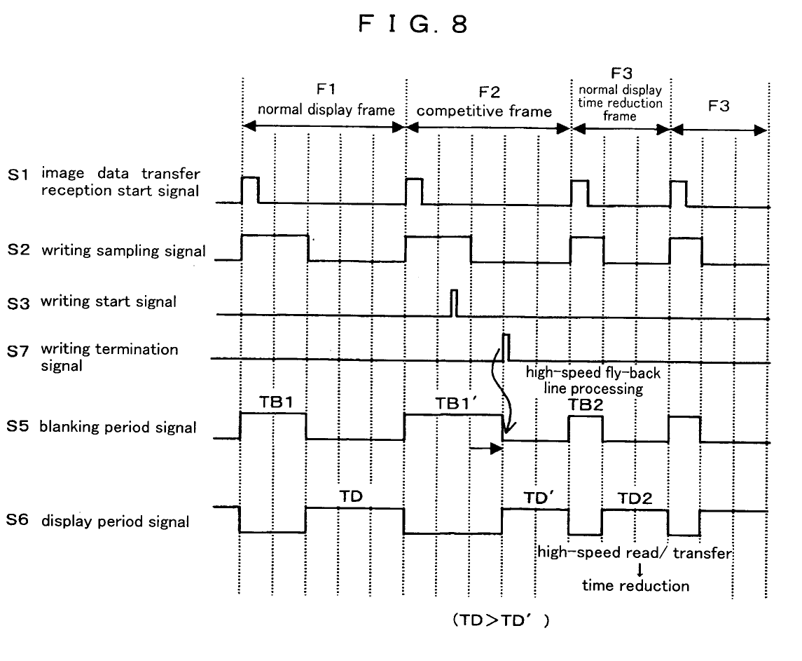

Next, the operation of the image data display control device E according to the present preferred embodiment thus constituted is described referring to a timing chart shown in FIG. 8. In FIG. 8, the same reference symbols as those shown in FIG. 6 according to the preferred embodiment 3 denote the same components. The description is given below with a focus on the operation of the normal display blanking period setting register 3, the blanking period setting register for time-reduction in a normal display 13 and the blanking period change control circuit 5, and the operation of the normal display line cycle setting register 11, the line cycle setting register for competition time-reduction 12, the line cycle setting register for time-reduction in a normal display 14, and display control circuit 7. The operations in the normal display frame F1 and the competitive frame F2 are similar to those in the preferred embodiment 3, and not described again.

In the normal display time reduction frame F3, the blanking period change control circuit 5 sets the blanking period TB2 based on the output of the blanking period setting register for time-reduction in a normal display 13. The blanking period TB2 is shorter than in the normal display in order to alleviate the reduction of the frame frequency resulting from the extension of the blanking period in the competitive frame F2. Therefore, in the blanking period TB2, a vertical processing of the fly-back lines are performed at a speed higher than in the other blanking periods.

Further, when the blanking period TB2 is terminated in the normal display time reduction frame F3, the line cycle set value S8 of the line cycle setting register for time reduction in a normal display 14 is selected, and the display period TD2 that is time-reduced is set based on the product of the line cycle set value S8 and the number of the display lines. The line cycle set value S8 of the line cycle setting register for time reduction in a normal display 14 has a line cycle shorter than that in the normal display in order to alleviate the reduction of the frame frequency resulting from the extension of the blanking period in the competitive frame F2. Therefore, the image data is read from the image memory 9 at the higher reading operation frequency f′ and transferred to the display device B in the normal display time reduction frame F3. Because the image data is read and transferred at a high speed in the normal display time reduction frame F3, the required display period TD2 is reduced. The operation in the normal display time reduction frame F3 is executed after that of the normal display time reduction frame F3, and the number of the operations can be arbitrarily set.

As described above, according to the present preferred embodiment, the reduction of the frame frequency can be further improved by performing a time-reduction processing of the blanking period and the display period in the normal display time reduction frame F3 in comparison to the preferred embodiment 3 in addition to the effects described in the preferred embodiments 1-3.

### Preferred Embodiment 5

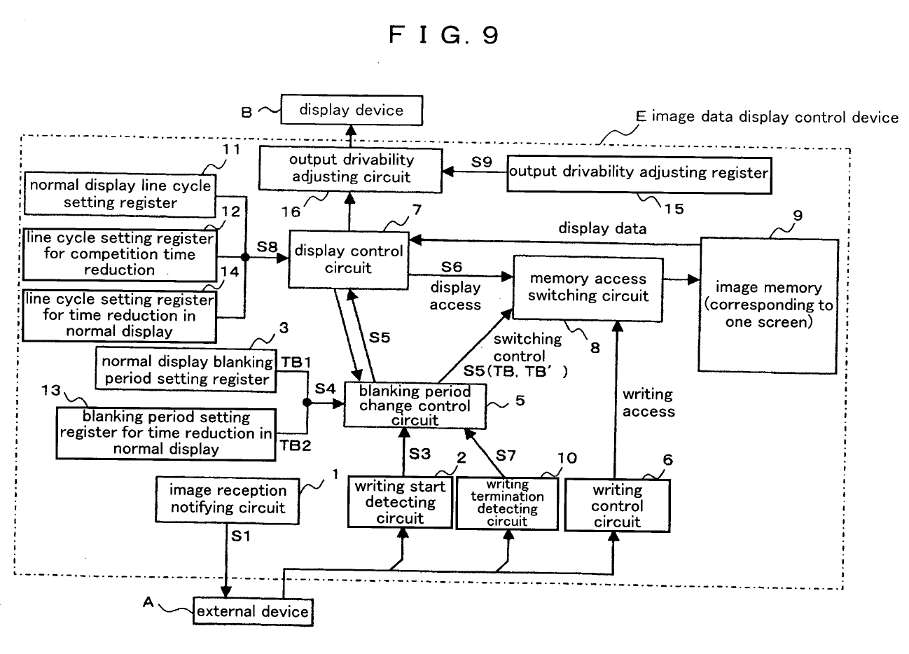

A preferred embodiment 5 of the present invention further promotes the reduction of power consumption based on the constitution according to the preferred embodiment 4. FIG. 9 is a block diagram showing a constitution of an image data display control device E according to the preferred embodiment 5. In FIG. 9, the reference symbols, that are the same as those shown in FIG. 7 according to the preferred embodiment 4, denote the same components. The constitution according to the present preferred embodiment is characterized as follows.

15 denotes an output drivability adjusting register. 16 denotes an output drivability adjusting circuit. The output drivability adjusting register 15 adjusts a drivability of an output voltage or an output current supplied to the display device B in accordance with the line cycle adjusted variably. The line cycle described here is one of the cycle lines set with the normal display line cycle setting register 11, the line cycle setting register for competition time-reduction 12 and the line cycle setting register for time-reduction in a normal display 14.

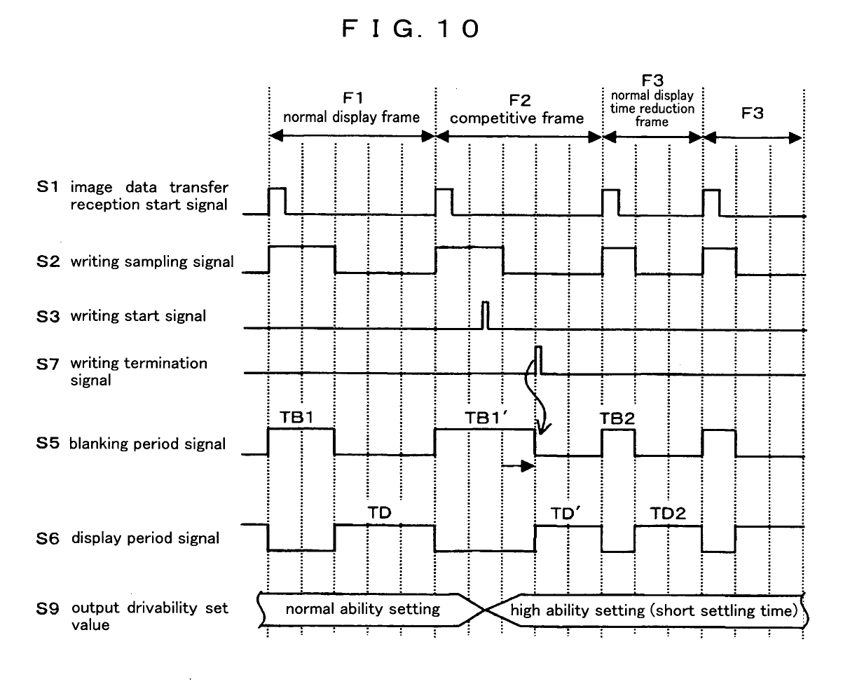

Next, the operation of the image data display control device E according to the present preferred embodiment thus constituted is described referring to a timing chart shown in FIG. 10. In FIG. 10, the reference symbols that are the same as those shown in FIG. 8 according to the preferred embodiment 4, denote the same signals. S9 denotes an output drivability set value notified by the output drivability adjusting register 15 to the output drivability adjusting circuit 16.

Here, the description is given below with a focus on the operations of the output drivability adjusting register 15 and the output drivability adjusting circuit 16. In the normal display frame F1, the output drivability adjusting register 15 notifies the output drivability adjusting circuit 16 of the drivability set value S9 showing a normal level of capability as the output drivability. Accordingly, the output drivability adjusting circuit 16 transfers the image data to the display device B with the drivability depending on the line cycle in the normal frame.

After the rise of the writing start signal S3 in the competitive frame F2 and in the normal display time reduction frame F3, the output drivability adjusting register 15 notifies the output drivability adjusting circuit 16 of the drivability set value S9 showing a high level of capability as the output drivability. Accordingly, the output drivability adjusting circuit 16 transfers the image data to the display device B with the drivability in response to the line cycle in the competitive frame F2 or the normal display time reduction frame F3.

Through implementing the foregoing control operation, an output drive time (settling time) to the line cycle is optimized, there is no excess and deficiency of the output drivability and any unnecessary power consumption is eliminated. For example, in order to reduce the output drive time in an output amplifier for driving a display image data line, it is necessary to set a steady-state current to a large value. In the case where the output drivability adjusting circuit 16 is not provided, the output drivability in response to a shortest value in the line cycle that can be arbitrarily set becomes necessary. Therefore, the output drivability results in an over-spec state in any line cycle other than the one showing the shortest value, which unnecessarily consumes power.

In the present preferred embodiment wherein the output drivability adjusting circuit 16 is provided, the output drivability adjusting circuit 16 sets the output drivability to a normal level of capability in the normal display frame F1, while setting the output drivability to a high level of capability after the rise of the writing start signal S3 in the competitive frame F2 and in the normal display time reduction frame F3. As a result, the output drive time with respect to any arbitrarily line cycle can be optimized, the excess deficiency of the output drivability can be avoided, and any unnecessary power consumption can be eliminated in comparison to the preferred embodiment 4.

As described above, according to the present preferred embodiment, because the optimized output drivability can be set in the normal display frame F1, the competitive frame F2 and the normal display time reduction frame F3 in addition to the effects described in the preferred embodiments 1-4, the power consumption can be reduced in comparison to the preferred embodiment 4.

Though the preferred exempla of this invention has been described in detail, it will be understood that various modifications may be made therein, and it is intended to cover in the appended claims all such modifications as fall within the true spirit and scope of this invention.

What is claimed is:

1. An image data display control device comprising:
an image memory for memorizing an image data temporarily;
a writing control circuit for writing the image data in the image memory during a blanking period when an image is displayed upon receiving an input of the image data thereto;
a display control circuit for reading the image data from the image memory during a display period when the image is displayed;
a memory access switchover circuit for relaying a data access to the image memory by the writing control circuit and a data access to the image memory by the display control circuit and
a blanking period change control circuit for extending the blanking period in a display frame at a timing of reception of start of the writing operation with respect to the image memory by the wiring control circuit when the start of the writing operation is received, wherein
the writing control circuit outputs a request for writing the image data to the memory access switchover circuit upon receiving the input of the image data, and
the memory access switchover circuit switches over from the data access by the display control circuit to the data access by the writing control circuit upon receiving the writing request.

2. The image data display control device as claimed in claim 1, wherein
the blanking period change control circuit extends the blanking period of the display frame at the timing of reception of start of the writing operation upon receiving a start of writing to the image memory by the wiring control circuit, and returns the blanking period of the next frame or a few frame from that to a normal time length thereof.

3. The image data display control device as claimed in claim 1, wherein
the blanking period change control circuit sets the extended blanking period so as to have an enough time for the writing control circuit to write the image data in the image memory.

4. The image data display control device as claimed in claim 1, wherein
the blanking period change control circuit returns the extended blanking period to the original period upon receiving termination of the writing operation to the image memory by the writing control circuit.

5. The image data display control device as claimed in claim 1, wherein
the display control circuit sets a data reading frequency in the extended blanking period to be higher than a data reading frequency in the blanking period which is not extended.

6. The image data display control device as claimed in claim 1, wherein
the blanking period change control circuit reduces the blanking period in on and after the relevant frame based on the frame in which the blanking period is extended.

7. The image data display control device as claimed in claim 6, wherein
the blanking period change control circuit makes the shortened blanking period to be shorter than the unextended blanking period.

8. The image data display control device as claimed in claim 5, further comprising an output drivability adjusting circuit for adjusting a signal level of the image data outputted by the display control circuit, wherein
the output drivability adjusting circuit adjusts the signal level in the extended blanking period in accordance with the reading frequency in the relevant blanking period.

9. An image data display control method comprising:
a writing step for writing an image data in an image memory during a blanking period at the time of displaying an image when the image data is inputted;
a reading step for reading the image data from the image memory during a display period at the time of displaying an image; and
a blanking period changing step for instructing extension of the blanking period in response to start of the writing operation to the image memory in the writing step, wherein
the writing step and the reading step are switched over mutually depending on whether or not the image data is inputted.

10. The image data display control method as claimed in claim 9, wherein
in the blanking period changing step, the blanking period of the display frame is extended at the timing of reception of start of the writing operation upon receiving a start of the writing operation to the image memory by the writing step, and the blanking period of the next frame or a few frame from that is returned to a normal time length thereof.

11. The image data display control method as claimed in claim 9, wherein
the extended blanking period is set so as to have an enough time for the image data to be written in the image memory in the writing step in the blanking period changing step.

12. The image data display control method as claimed in claim 9, wherein
the extended blanking period is returned to the original period upon receiving termination of the writing operation to the image memory in the writing step in the blanking period changing step.

13. The image data display control method as claimed in claim 9, wherein
a data reading frequency is set in the extended blanking period to be higher than the data reading frequency in the blanking period which is not extended in the reading step.

14. The image data display control method as claimed in claim 9, wherein
the blanking period is shortened in on and after the relevant frame based on the frame in which the blanking period is extended in the blanking period changing step.

15. The image data display control method as claimed in claim 14, wherein
the reduced blanking period is shortened to be shorter than the unextended blanking period in the blanking period changing step.

16. The image data display control method as claimed in claim 1, further comprising an output drivability adjusting step for adjusting a signal level of the image data outputted in the reading step, wherein
the signal level is adjusted in the extended blanking period in accordance with the reading frequency in the relevant blanking period in the output drivability adjusting step.
